(19) United States
(12) Patent Application Publication
(10) Pub. No.: US 2023/0246324 A1
(43) Pub. Date: Aug. 3, 2023

(54) MODULAR SLOT CONNECTION STRUCTURE AND ELECTRONIC DEVICE HAVING SAME

(71) Applicant: FIH CO., LTD., NEW TAIPEI (TW)

(72) Inventors: SHING-HUEI LIN, NEW TAIPEI (TW); KUO-HENG SUN, NEW TAIPEI (TW); CHO-KANG HSU, NEW TAIPEI (TW)

(21) Appl. No.: 17/723,667

(22) Filed: Apr. 19, 2022

(30) Foreign Application Priority Data
Jan. 28, 2022 (TW) 111104209

(51) Int. Cl. H01Q 1/24

(52) U.S. Cl. CPC H01Q 1/243

(57) ABSTRACT

A securing structure is applicable in an electronic device for securing an antenna module in a slot defined between a side frame and a middle frame of the electronic device. The securing structure includes a first assembly, a second assembly, and a third assembly. The first assembly secures the antenna module in a first direction, the first assembly includes a plastic piece for spacing the antenna module from the side frame with a predetermined distance. The second assembly secures the antenna module in a second direction, the second assembly includes a limiting assembly formed by protruding from the middle frame. The third assembly secures the antenna module in a third direction, the third assembly includes a pressing piece for pressing the antenna module in the third direction. The application also provides an electronic device with the securing structure.

### CROSS-REFERENCE TO RELATED APPLICATIONS

This application claims priority to Taiwan Patent Application No. 111104209 filed on Jan. 28, 2022, in Taiwan Intellectual Property Office, the contents of which are incorporated by reference herein.

### TECHNICAL FIELD

The present disclosure relates to the field of wireless communication technology, in particular to securing structure and electronic device having the securing structure.

### BACKGROUND

With the advancement of wireless communication technology, electronic devices such as mobile phones continue to become more diversified functions, thinner and lighter, and faster and more efficient in data transmission. The space in mobile phones that can accommodate antennas is becoming smaller, and with the continuous development of wireless communication technology, the demand for antenna bandwidth continues to increase. How to design an antenna with a wider bandwidth and higher efficiency in a limited space is an important issue facing antenna design.

Therefore, there is a room for improvement.

### BRIEF DESCRIPTION OF THE DRAWINGS

FIG. 1 is a schematic diagram of an electronic device having a securing structure of at least one embodiment of the present disclosure.

FIG. 2 is a partial schematic diagram of the electronic device having the securing structure of at least one embodiment of the present disclosure.

FIG. 3 is another partial schematic diagram of the electronic device having the securing structure of at least one embodiment of the present disclosure.

FIG. 4 is an exploded schematic diagram of the electronic device having the securing structure of FIG. 2.

FIG. 5 is a planform schematic diagram of the electronic device having the securing structure of FIG. 2.

FIG. 6 is a first cross-sectional schematic diagram of the electronic device having the securing structure of FIG. 2.

FIG. 7 is a second cross-sectional schematic diagram of the electronic device having the securing structure of FIG. 2.

FIG. 8 is third cross-sectional schematic diagram of the electronic device having the securing structure of FIG. 2.

FIG. 9 is a fourth cross-sectional schematic diagram of the electronic device having the securing structure of FIG. 2.

### DETAILED DESCRIPTION

In order to make the purpose, technical solutions and advantages of the embodiments of the present disclosure clearer, the technical solutions in the embodiments of the present disclosure will be described clearly and completely in conjunction with the drawings in the embodiments of the present disclosure. Based on the embodiments of the present disclosure, all other embodiments obtained by those of ordinary skill in the art without creative work shall fall within the scope of protection of the present disclosure.

Those skilled in the art should understand that, in the disclosure of the present disclosure, “at least one” refers to one or more, and “multiple” refers to two or more. Unless otherwise defined, all technical and scientific terms used herein have the same meaning as commonly understood by those skilled in the technical field in the present disclosure. The terminology used in the specification of present disclosure is only for the purpose of describing specific embodiments, and is not intended to limit the present disclosure.

It can be understood that, unless otherwise specified in the present disclosure, the symbol “/” means “or”. For example, AB can mean A or B. “A and/or B” in the present disclosure is only an associative relationship describing the associated objects, which means that there can be three relationships: A alone, B alone, and A and B together.

It can be understood that, in the disclosure of the present disclosure, the words such as “first” and “second” are only used for the purpose of distinguishing a description, and cannot be understood as indicating or implying relative importance, nor as indicating or implying any order. The features defined with “first” and “second” may explicitly or implicitly include one or more of the features. In the description of the embodiments of the present disclosure, the words such as “exemplary” or “for example” are used as examples, illustrations, or indications. Any embodiment or design solution described as “exemplary” or “for example” in the embodiments of the present disclosure should not be construed as being more preferable or advantageous than other embodiments or design solutions. To be precise, the words such as “exemplary” or “for example” are used to present related concepts in a specific manner.

Those skilled in the art should understand that, in the disclosure of the present disclosure, the terms “longitudinal”, “lateral”, “upper”, “lower”, “front”, “rear”, “left”, “right”, the orientation or positional relationship indicated by “vertical”, “horizontal”, “top”, “bottom”, “inner”, “outer”, etc. are based on the orientation or positional relationship shown in the drawings, which is only for the convenience of describing the present disclosure and to simplify the description, rather than indicating or implying that the device or element referred to must have a specific orientation, or be constructed and operated in a specific orientation, thus the above terms should not be understood as limiting the present disclosure.

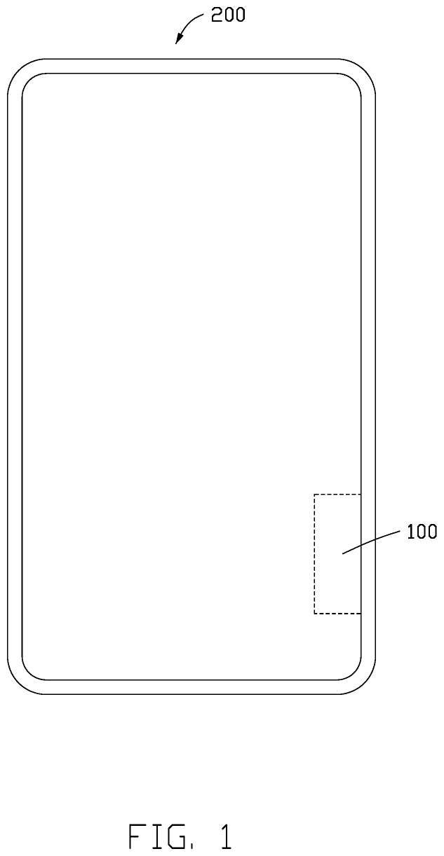

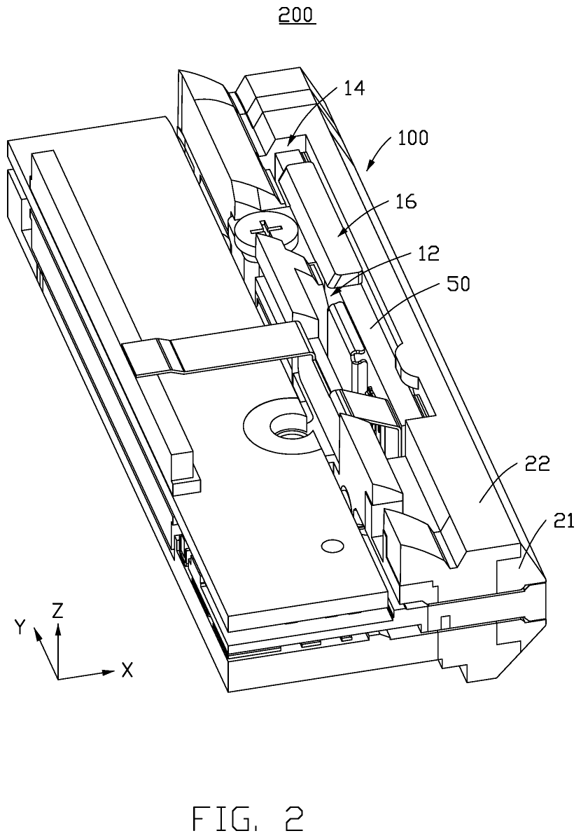

FIGS. 1 and 2 illustrate a securing structure 100 applied in an electronic device 200 in accordance with at least one embodiment of the present disclosure. The securing structure 100 is configured to secure an antenna module 50 that can transmit and receive radio waves and exchange wireless signals. The electronic device 200 may be a handheld communication device (such as a mobile phone), a folding machine, a smart wearable device (such as a watch, earphone, etc.), a tablet computer, a personal digital assistant (personal digital assistant, PDA), a display device, a gaming machine, an internet of things (IOT) device, an automobile, and not specifically limited here. The securing structure 100 is configured to secure the antenna module 50 in a slot inside a frame of the electronic device 200. The securing structure 100 may also be described or named as a modular slot connection structure.

Referring to FIG. 1, the securing structure 100 is arranged on a side of the electronic device 200, but the position of the securing structure 100 is not limited to that shown in FIG. 1, the securing structure 100 may also be arranged on a left side, a right side, a top side, and/or a bottom side of the frame of the electronic device 200. In other embodiments, two or more securing structures 100 may be jointly or separately arranged a left side, a right side, a top side, and/or a bottom side of the frame of the electronic device 200.

The electronic device 200 may adopt one or more of the following communication technologies: BLUETOOTH (BT) communication technology, global positioning system (GPS) communication technology, WI-FI communication technology, global system for mobile communications (GSM) communication technology, wideband code division multiple access (WCDMA) communication technology, long term evolution (LTE) communication technology, 5G communication technology, SUB-6G communication technology and other future communication technologies.

In one embodiment of the present disclosure, the electronic device 200 is a mobile phone as an example for description.

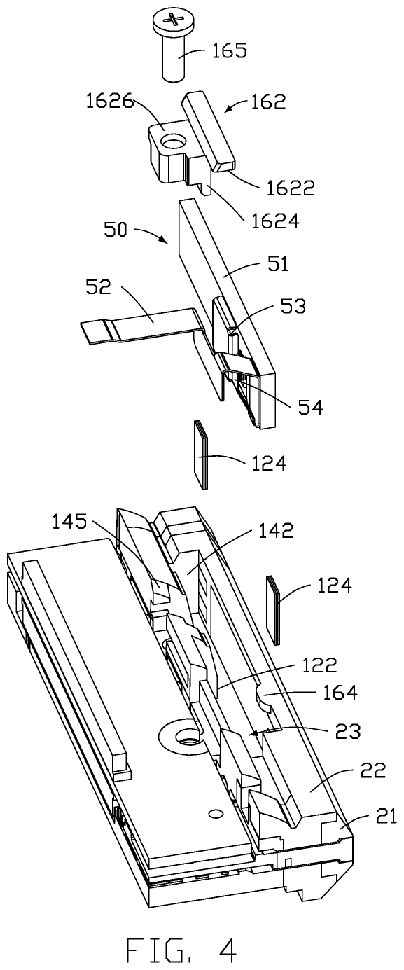

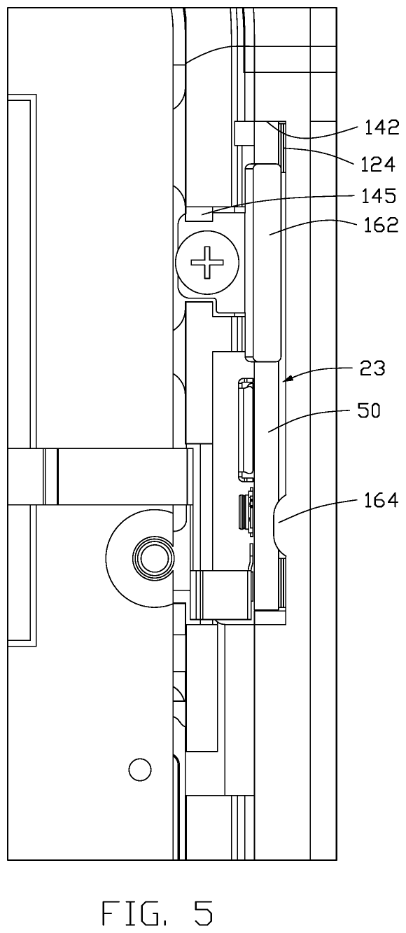

Referring to FIGS. 2, 3, 4, and 5, the electronic device 200 includes a side frame 21 and a middle frame 22 corresponding to the side frame 21. A slot 23 is formed between the side frame 21 and the middle frame 22. The slot 23 may receive the antenna module 50.

In one embodiment of the present disclosure, the electronic device 200 further includes a backplane (not shown in the figures) and a display unit (not shown in the figures). The side frame 21 may be made of metal or other conductive material. The side frame 21 is disposed on the edge of the backplane and forms an accommodating space (not shown in the figures) together with the backplane. An opening (not shown in the figures) is provided on the side of the side frame 21 opposite to the backplane for accommodating the display unit. The display unit has a display plane, and the display plane is exposed in the opening. It can be understood that the display unit can be combined with a touch sensor to form a touch screen. The touch sensor can be touch panel or touch sensitive panel.

In other embodiments, the electronic device 200 may further include one or more elements as follows: a processor, a circuit board, a memory, a power source, an input and output circuit, an audio assembly (such as a microphone and a speaker), a multimedia assembly (such as front camera and/or rear camera), a sensor assembly (such as a proximity sensor, a range sensor, an ambient sensor, an acceleration sensor, a gyroscope, a magnetic sensor, a pressure sensor and/or a temperature sensor), etc.

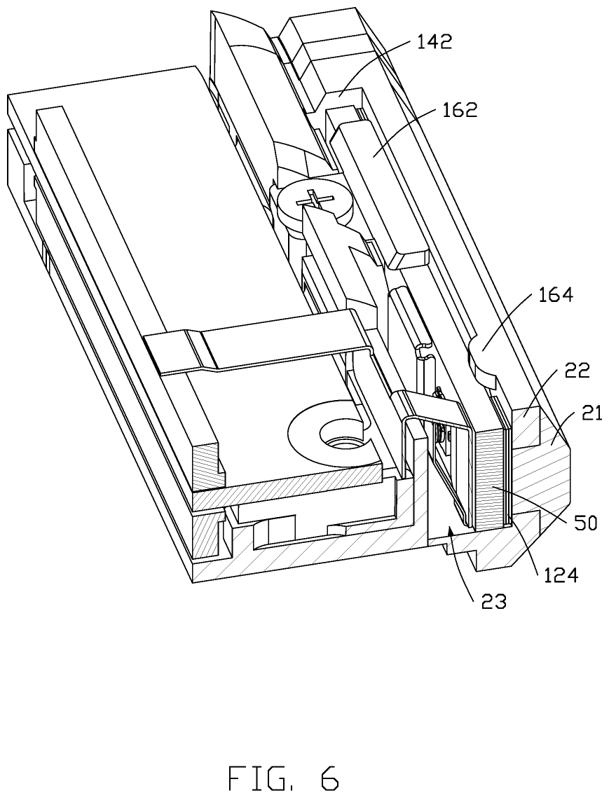

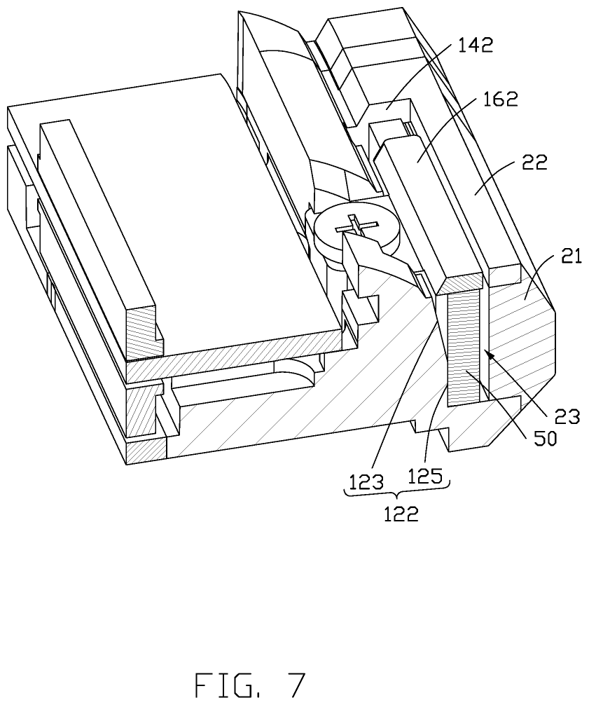

Referring to FIGS. 2, 4, 6, and 7, the securing structure 100 includes a first assembly 12, a second assembly 14, and a third assembly 16.

The first assembly 12 is configured to secure the antenna module 50 to the electronic device 200 in a first direction. The first assembly 12 includes a first rib 122 and a plastic piece 124. The first rib 122 is formed by a protrusion of the middle frame 22 and towards the slot 23 and the side frame 21. The first rib 122 is positioned at an edge of the slot 23. The first rib 122 includes a first chamfered portion 123 and a first pressing portion 125. The first chamfered portion 123 and the first pressing portion 125 are connected. The first chamfered portion 123 is configured to guide the antenna module 50 into the slot 23. The first pressing portion 125 is configured to resist the antenna module 50 in the first direction. The plastic piece 124 infills a gap between the antenna module 50 and the side frame 21, and the plastic piece 124 is between the antenna module 50 and the side frame 21. Specifically, the first pressing portion 125 resists a side surface of the antenna module 50, the gap is formed from another side surface of the antenna module 50 opposite to the first pressing portion 125 to the side frame 21 with a predetermined distance. That is, the first rib 122 and the plastic piece 124 resist opposite side surfaces of the antenna module 50 to secure the antenna module 50 to the electronic device 200 in the first direction.

In another embodiment, the predetermined distance between the antenna module 50 and the side frame 21 may be configured for efficient coupling of signals between the antenna module 50 and the side frame 21. The predetermined distance may be about 0.25-0.35 millimeters, electively about 0.3 millimeters. The plastic piece 124 may be of Mylar, which has flexibility. The plastic piece 124 may be configured to adjust and control a predetermined distance between the antenna module 50 and the side frame 21.

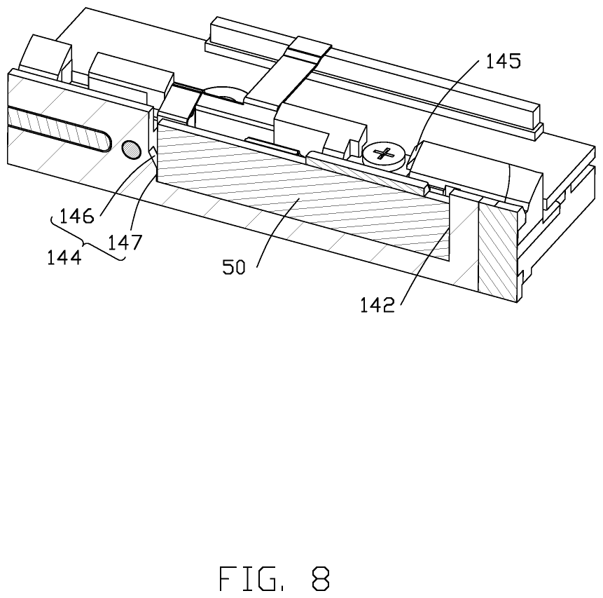

Referring to FIGS. 2, 4, 5, and 8, the second assembly 14 is configured to secure the antenna module 50 to the electronic device 200 in a second direction. The second assembly 14 includes a limiting member 142 and a second rib 144. The limiting member 142 is a limiting groove formed in the middle frame 22, the limiting groove surrounds the slot 23. In one embodiment, the limiting assembly 142 surrounds at least three sides of the slot 23. The second rib 144 is formed by a protrusion of the limiting member 142 and towards the slot 23 and the other side of the limiting member 142, the second rib 144 is positioned at an edge of the slot 23. The second rib 144 has a second chamfered portion 146 and a second pressing portion 147. The second chamfered portion 146 and the second pressing portion 147 are connected. The second chamfered portion 146 is configured to guide the antenna module 50 into the slot 23. The second pressing portion 147 is configured to resist against the antenna module 50 in the second direction. The limiting member 142 and the second rib 144 resist against opposite side surfaces of the antenna module 50, so as to secure the antenna module 50 in the second direction.

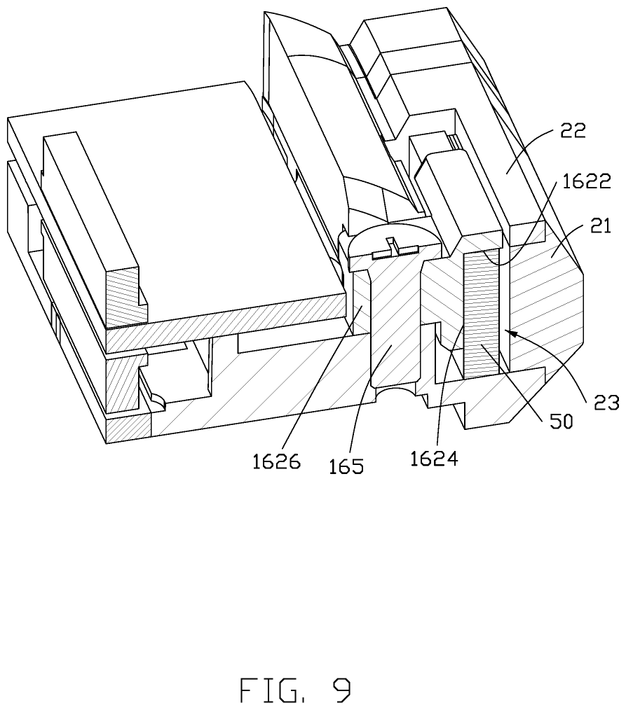

Referring to FIGS. 2, 4, 5, and 9, the third assembly 16 is configured to secure the antenna module 50 in a third direction. The third assembly 16 includes a pressing piece 162 and a first latch 164. The pressing piece 162 is detachably arranged on the middle frame 22 and configured to press against the antenna module 50. The pressing piece 162 includes a first pressing surface 1622 and a second pressing surface 1624 adjacent to the first pressing surface 1622. The first pressing surface 1622 is configured to press the antenna module 50 in the third direction, the second pressing surface 1624 is configured to press the antenna module 50 in the first direction. In one embodiment, the first pressing surface 1622 is substantially perpendicularly connected to the second pressing surface 1624. The pressing piece 162 further includes a lock portion 1626. A lock piece 165 may be inserted through the lock portion 1626 and the middle frame 22, so the pressing piece 162 can be secured on the middle frame 22. In one embodiment, the lock portion 1626 defines a threaded hole, the lock piece 165 is a screw, the screw may be inserted through the threaded hole, so as to secure the pressing piece 162 to the middle frame 22. When the pressing piece 162 is arranged on the middle frame 22, the first pressing surface 1622 faces the slot 23 and the side frame 21, and presses the antenna module 50 in the first direction. The second pressing surface 1624 extends out of the slot 23, and presses the antenna module 50 in the third direction.

The first latch 164 is a protrusion from the middle frame 22 towards the slot 23 and the pressing piece 162. The first latch 164 is configured to press against the antenna module 50 in the third direction. In one embodiment, the first pressing surface 1622 and the first latch 164 may press a same side surface of the antenna module 50 in the third direction.

The second assembly 14 further includes a second latch 145. The second latch 145 is a protrusion from the middle frame 22 towards the pressing piece 162. The second latch 145 presses against the lock portion 1626 to the middle frame 22, so as to further secure the pressing piece 162.

In one embodiment, the first direction, the second direction, and the third direction are perpendicular to each other. For instance, the first direction may be an X-axis direction, the second direction may be a Y-axis direction, the third direction may be a Z-axis direction.

In one embodiment, the antenna module 50 may be but is not limited to a 5G antenna module. The antenna module 50 may include a circuit board 51, a wiring module 52, a signal transceiver 53, and an elastic piece 54. The circuit board 51 may carry the signal transceiver 53 for transmitting and receiving wireless communication signals. The wiring module 52 is connected to an end of the circuit board 51, the elastic piece 54 is arranged on the circuit board 51, the wiring module 52 and the elastic piece 54 are configured to ground the antenna module 50. The wiring module 52 may be connected to a circuit board of the electronic device 200 for grounding. The elastic piece 54 may be connected to the middle frame 22 for grounding. The antenna module 50 may further include more electronic components, such as a connector and a shield cover.

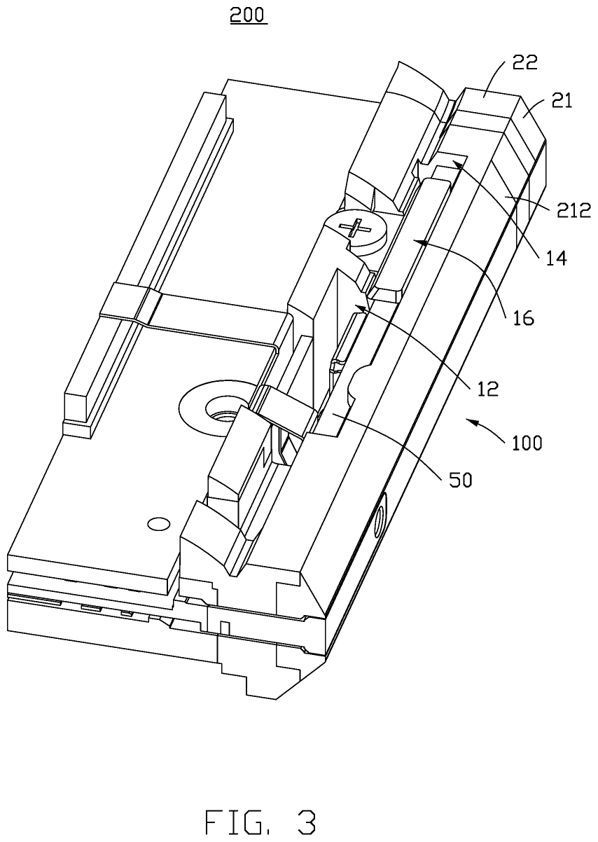

Referring to FIG. 3, the side frame 21 further includes an antenna pattern 212 extending along the side frame 21. In one embodiment, an end of the antenna module 50 is flush with an end of the antenna pattern 212.

The securing structure 100 arranges at least one securing assembly in each direction for securing the antenna module 50 in the slot 23 formed between the side frame 21 and the middle frame 22 in a plurality of directions, so the slot 23 may receive and secure the antenna module 50, which improves internal space utilization of the electronic device 200 and facilitates the overall structure design of the electronic device 200.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A securing structure applicable in an electronic device and configured to secure an antenna module in a slot defined between a side frame and a middle frame of the electronic device, the securing structure comprising:
a first assembly configured to secure the antenna module in a first direction, the first assembly comprising a plastic piece for spacing the antenna module from the side frame with a predetermined distance;
a second assembly configured to secure the antenna module in a second direction, the second assembly comprising a limiting member formed by the middle frame; and
a third assembly configured to secure the antenna module in a third direction, the third assembly comprising a pressing piece for pressing the antenna module in the third direction.

2. The securing structure according to claim 1, wherein the first assembly further comprises a first rib having a first chamfered portion, the first chamfered portion is configured to guide the antenna module into the slot.

3. The securing structure according to claim 2, wherein the first rib further comprises a first pressing portion, the first pressing portion and the first chamfered portion are connected, the first pressing portion is configured to resist the antenna module for securing the antenna module in the first direction.

4. The securing structure according to claim 1, wherein the second assembly further comprises a second rib having a second chamfered portion, the second chamfered portion is configured to guide the antenna module into the slot.

5. The securing structure according to claim 4, wherein the second rib further comprises a second pressing portion, the second chamfered portion and the second pressing portion are connected, the second pressing portion is configured to resist the antenna module for securing the antenna module in the second direction.

6. The securing structure according to claim 1, wherein the third assembly further comprises a first latch configured to press the antenna module in the third direction for securing the antenna module in the third direction.

7. The securing structure according to claim 1, wherein the pressing piece comprises a first pressing surface and a second pressing surface adjacent to the first pressing surface, the first pressing surface is configured to press the antenna module in the third direction, the second pressing surface is configured to press the antenna module in the first direction.

8. The securing structure according to claim 1, wherein the pressing piece comprises a lock portion for securing the pressing piece to the middle frame.

9. The securing structure according to claim 8, wherein the second assembly further comprises a second latch configured to resist against the pressing piece for securing the pressing piece to the middle frame.

10. An electronic device comprising:
a side frame;
a middle frame;
a slot defined between the side frame and the middle frame;
an antenna module disposed in the slot; and
a securing structure comprising:
a first assembly configured to secure the antenna module in a first direction, the first assembly comprising a plastic piece for spacing the antenna module from the side frame with a predetermined distance;
a second assembly configured to secure the antenna module in a second direction, the second assembly comprising a limiting member formed by the middle frame; and
a third assembly configured to secure the antenna module in a third direction, the third assembly comprising a pressing piece for pressing the antenna module in the third direction.

11. The electronic device according to claim 10, wherein the first assembly further comprises a first rib having a first chamfered portion, the first chamfered portion is configured to guide the antenna module into the slot.

12. The electronic device according to claim 11, wherein the first rib further comprises a first pressing portion, the first pressing portion and the first chamfered portion are connected, the first pressing portion is configured to resist the antenna module for securing the antenna module in the first direction.

13. The electronic device according to claim 10, wherein the second assembly further comprises a second rib having a second chamfered portion, the second chamfered portion is configured to guide the antenna module into the slot.

14. The electronic device according to claim 13, wherein the second rib further comprises a second pressing portion, the second chamfered portion and the second pressing portion are connected, the second pressing portion is configured to resist the antenna module for securing the antenna module in the second direction.

15. The electronic device according to claim 10, wherein the third assembly further comprises a first latch configured to press the antenna module in the third direction for securing the antenna module in the third direction.

16. The electronic device according to claim 10, wherein the pressing piece comprises a first pressing surface and a second pressing surface adjacent to the first pressing surface, the first pressing surface is configured to press the antenna module in the third direction, and the second pressing surface is configured to press the antenna module in the first direction.

17. The electronic device according to claim 10, wherein the pressing piece comprises a lock portion for securing the pressing piece to the middle frame.

18. The electronic device according to claim 17, wherein the second assembly further comprises a second latch, the second latch is configured to resist the pressing piece for securing the pressing piece to the middle frame.

19. The electronic device according to claim 10, wherein the antenna module comprises an elastic piece and a wiring module, the antenna module is grounded to the middle frame through the elastic piece and the wiring module.

20. The electronic device according to claim 10, wherein the side frame comprises an antenna pattern extending along the side frame, an end of the antenna module aligns with an end of the antenna pattern.
